(19) United States
(12) Patent Application Publication
(10) Pub. No.: US 2007/0064855 A1
(43) Pub. Date: Mar. 22, 2007

(54) NETWORK DEVICE FOR GENERATING DYING GASP SIGNALS

(75) Inventor: SHIN-HUEI YEH, TUCHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,053

(22) Filed: Mar. 4, 2006

(30) Foreign Application Priority Data
Aug. 26, 2005 (TW) 94129254

(51) Int. Cl. H04L 23/00

(52) U.S. Cl. 375/377

(57) ABSTRACT

A network device for generating dying gasp signals includes an interrupt generating circuit, an external connecting circuit for connecting to another network device or a network, an internal processing circuit, a capacitor and a switch circuit. The interrupt generating circuit generates interrupt signals when the network device is without power. The internal processing circuit connected to the interrupt generating circuit, generates dying gasp signals according to the interrupt signals, and includes an input end. The switch circuit includes a first input end connected to the interrupt generating circuit, a second input end connected to the input end of the internal processing circuit and an output end connected to the external connecting circuit. The output end is connected to the external connecting circuit. The capacitor has one end connected to the input end of the internal processing circuit and the second input end of the switch circuit, and another end grounded.

### FIELD OF THE INVENTION

The present invention relates to network communication devices, and particularly to a network device for generating dying gasp signals.

### DESCRIPTION OF RELATED ART

The growing requirements for internet data have increased the popularity of broadband access services. Digital Subscriber Loop (DSL) technology has become a main broadband access technology in the world due to its convenient deployment, good performance, and lower cost.

Asymmetrical Digital Subscriber Loop (ADSL) is the most popular kind of DSL technology. In a typical application, a Customer's Premises Equipment (CPE) is usually configured, controlled, maintained and upgraded by a Central Office (CO). The International Telecommunications Union (ITU) standard G992.1 relating to ADSL prescribes that when an ADSL CPE runs out of power, the ADSL CPE must generate dying gasp signals, and send the dying gasp signals to an ADSL CO via an Embedded Operation Channel (EOC).

However, if the ADSL CPE is completely without power, it cannot send out dying gasp signals. Therefore, power saving elements, for example capacitors, are used for supplying power to generate dying gasp signals. One or more capacitors with high capacitance are needed in order to supply sufficient power. Thus, there is generally enough time for an ADSL CPE to generate dying gasp signals and send the dying gasp signals to the ADSL CO. Nevertheless, the capacitors increase the cost of the ADSL CPE. In addition, the capacitors take up more space on a printed circuit board, and thus make the layout of the printed circuit board problematic.

### SUMMARY OF INVENTION

An exemplary embodiment of the present invention provides a network device for generating dying gasp signals. The network device includes an interrupt generating circuit, an external connecting circuit, an internal processing circuit, a switch circuit, and a capacitor. When there is no power supplied to the network device, the interrupt generating circuit generates an interrupt signal. The external connecting circuit is used for connecting to another network device or a network. The internal processing circuit is connected to the interrupt generating circuit, is used for generating a dying gasp signal according to the interrupt signal, and includes an input end. The switch circuit includes a first input end, a second input end, and an output end. The first input end is connected to the interrupt generating circuit, the second input end is connected to the input end of the internal processing circuit, and the output end is connected to the external connecting circuit. The capacitor has one end connected to the input end of the internal processing circuit and the second input end of the switch circuit, and another end connected to ground.

Another exemplary embodiment of the present invention provides a network device for generating dying gasp signals. The network device includes an interrupt generating circuit, an external connecting circuit, an internal processing circuit, a switch circuit, a voltage adjusting circuit, and a capacitor. When there is no power supplied to the network device, the interrupt generating circuit generates an interrupt signal. The external connecting circuit is used for connecting to another network device or a network. The internal processing circuit is connected to the interrupt generating circuit, is used for generating a dying gasp signal according to the interrupt signal. The switch circuit includes a first input end, a second input end, and an output end. The first input end is connected to the interrupt generating circuit, and the output end is connected to the external connecting circuit. The voltage adjusting circuit is connected to the internal processing circuit and the second input end of the switch circuit. The capacitor has one end connected to the voltage adjusting circuit, and another end connected to ground.

When the network device runs out of power, the external connecting circuit is shut down immediately via the switch circuit, and thus power consumption is decreased. Therefore, the internal processing circuit has enough time to generate dying gasp signals.

Other advantages and novel features will become more apparent from the following detailed description of preferred embodiments when taken in conjunction with the accompanying drawings, in which:

### BRIEF DESCRIPTION OF DRAWINGS

FIG. 1 is a block diagram of a network device for generating dying gasp signals of an exemplary embodiment of the present invention;

FIG. 2 is a block diagram of a network device for generating dying gasp signals of another exemplary embodiment of the present invention; and

FIG. 3 is a circuit diagram of a switch circuit of each of the above exemplary embodiments.

### DETAILED DESCRIPTION

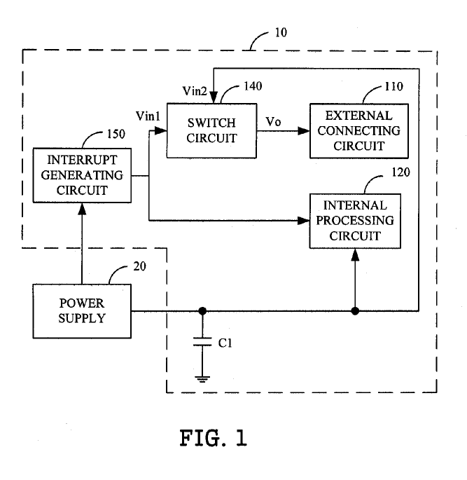

FIG. 1 is a block diagram of a network device for generating dying gasp signals 10 (hereinafter the network device 10) of an exemplary embodiment of the present invention. The network device 10 generates a dying gasp signal, and sends the dying gasp signal to an external managing device (not shown). In the exemplary embodiment, the network device 10 is an Asymmetrical Digital Subscriber Loop (ADSL) device generating a dying gasp signal and sending the dying gasp signal to a central office device. In the exemplary embodiment, the network device 10 includes an external connecting circuit 110, an internal processing circuit 120, a switch circuit 140, an interrupt generating circuit 150, and a capacitor C1. A power supply 20 is connected to the interrupt generating circuit 150 and the capacitor C1 of the network device 10 for powering the network device 10. In the exemplary embodiment, the power supply 20 is an external power supply.

The interrupt generating circuit 150 is connected to the power supply 20, and generates an interrupt signal when the power supply 20 runs out of power. In the exemplary embodiment, the interrupt signal is a low voltage signal. The internal processing circuit 120 is connected to the interrupt generating circuit 150, and includes an input end connected to the power supply 20. When the power supply 20 runs out of power, the internal processing circuit 120 generates the dying gasp signal according to the interrupt signal generated by the interrupt generating circuit 150, and sends the dying gasp signal to the external managing device. In the exemplary embodiment, the internal processing circuit 120 includes a digital signal processor (not shown). In other exemplary embodiments, the internal processing circuit 120 also includes an analog front end (AFE) and a memory (not shown).

The external connecting circuit 110 is used for connecting to another network device or a network (not shown). In the exemplary embodiment, the external connecting circuit 110 includes an Ethernet switch and a wireless local area network card. The switch circuit 140 includes a first input end Vin1, a second input end Vin2, and an output end Vo. The first input end Vin1 is connected to the interrupt generating circuit 150, the second input end Vin2 is connected to the input end of the internal processing circuit 120 and the power supply 20, and the output end Vo is connected to the external connecting circuit 110. The capacitor C1 has one end connected to the input end of the internal processing circuit 120, the second input end Vin2 of the switch circuit 140, and the power supply 20, and another end connected to ground.

When the power supply 20 works normally, the capacitor C1 saves power, and the interrupt generating circuit 150 does not generate an interrupt signal; at the same time, the power supply 20 provides power to the internal processing circuit 120 and the switch circuit 140, and the network device 10 works normally. The switch circuit 140 outputs a voltage from the output end Vo thereof to the external connecting circuit 110 to make the external connecting circuit 110 operate accordingly.

When the power supply 20 runs out of power, the capacitor C1 releases power to the internal processing circuit 120 and the switch circuit 140 to maintain operation thereof. At the same time, the interrupt generating circuit 150 generates an interrupt signal, and sends the interrupt signal to the first input end Vin1 of the switch circuit 140 and to the internal processing circuit 120. When receiving the interrupt signal, the switch circuit 140 cuts down voltage outputs; that is, there is no voltage outputted to the external connecting circuit 110 from the output end Vo of the switch circuit 140. Therefore, the external connecting circuit 110 is shut down with no power consumption. The internal processing circuit 120 receives the interrupt signal, generates a dying gasp signal accordingly, and sends the dying gasp signal to the external managing device.

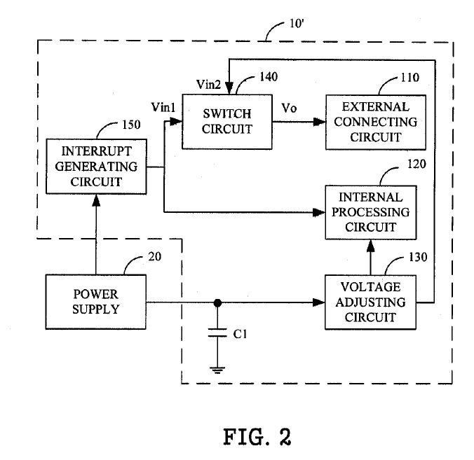

FIG. 2 is a block diagram of a network device 10′ of another exemplary embodiment of the present invention. The difference between the network device 10′ of this embodiment and the network device 10 of the above-described embodiment is that the network device 10′ further includes a voltage adjusting circuit 130 for adjusting voltages of the power supply 20. Other components of the network device 10′ are the same as those of the network device 10, and thus further description of these other components are omitted. The voltage adjusting circuit 130 includes one input end and two output ends. The input end is used for connecting to the power supply 20, and the output ends are respectively connected to the input end of the internal processing circuit 120 and the second input end Vin2 of the switch circuit 140. The end of the capacitor C1 connected to the power supply 20 is also connected to the input end of the voltage adjusting circuit 130.

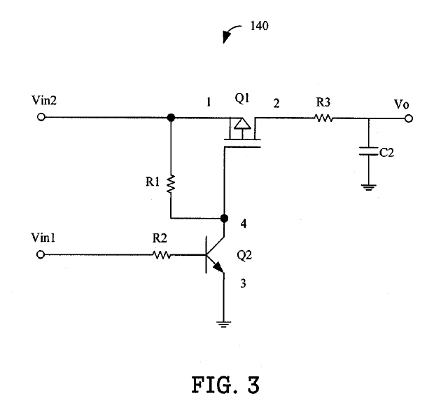

FIG. 3 is a circuit diagram of the switch circuit 140 of the network devices 10 and 10′. The switch circuit 140 includes a first transistor Q1, a second transistor Q2, a first resistor R1, a second resistor R2, and a third resistor R3. The first transistor Q1 includes a first control electrode, a first electrode 1, and a second electrode 2. The first electrode 1 is connected to the second input end Vin2. In the exemplary embodiment, the first transistor Q1 includes a Metal Oxide Semiconductor Field-Effect Transistor (MOSFET), the first control electrode is a gate electrode, the first electrode 1 is a source electrode, and the second electrode 2 is a drain electrode. The first resistor R1 has one end connected to the second input end Vin2, and another end connected to the first control electrode of the first transistor Q1.

The second transistor Q2 includes a second control electrode, a third electrode 3, and a fourth electrode 4. The third electrode 3 is grounded, and the fourth electrode 4 is connected to the first control electrode of the first transistor Q1. In the exemplary embodiment, the second transistor Q2 includes an NPN transistor, the second control electrode is a base electrode, the third electrode 3 is an emitter, and the fourth electrode 4 is a collector. The second resistor R2 is connected to the first input end Vin1 and to the second control electrode of the second transistor Q2. The third resistor R3 is connected between the second electrode of the first transistor Q1 and the output end Vo. In the exemplary embodiment, the switch circuit 140 further includes a capacitor C2. One end of the capacitor C2 is connected to the output end Vo, and another end of the capacitor C2 is connected to ground.

When the power supply 20 works normally, the interrupt generating circuit 150 does not generate interrupt signals. At this time, the second transistor Q2 and the first transistor Q1 are both turned on, and the switch circuit 140 outputs voltages from the output end Vo to make the external connecting circuit 110 operate accordingly. When the power supply 20 runs out of power, the interrupt generating circuit 150 generates an interrupt signal; that is, a low voltage signal. At this time, the second transistor Q2 and the first transistor Q1 are both shut down, and there is no voltage outputted from the output end Vo of the switch circuit 140. Therefore, the external connecting circuit 110 is shut down without power supply.

When the network device 10 or 10′ runs out of power, the external connecting circuit 110 is shut down immediately via the switch circuit 140, and thus power consumption is decreased. Therefore, the internal processing circuit 120 has enough time to generate dying gasp signals.

While various embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A network device for generating dying gasp signals, comprising: an interrupt generating circuit for generating an interrupt signal when there is no power supplied to the network device;
an external connecting circuit for connecting to another network device or a network;
an internal processing circuit connected to the interrupt generating circuit, for generating a dying gasp signal according to the interrupt signal, and comprising an input end;
a switch circuit comprising a first input end, a second input end, and an output end,
wherein the first input end is connected to the interrupt generating circuit, the second input end is connected to the input end of the internal processing circuit, and the output end is connected to the external connecting circuit; and
a capacitor having one end connected to the input end of the internal processing circuit and the second input end of the switch circuit, and another end connected to ground.

2. The network device for generating dying gasp signals as claimed in claim 1, wherein the input end of the internal processing circuit, the second input end of the switch circuit, and the capacitor are for connecting to a power supply.

3. The network device for generating dying gasp signals as claimed in claim 2, wherein the switch circuit comprises:
a first transistor comprising a first control electrode, a first electrode, and a second electrode, wherein the first electrode is connected to the second input end of the switch circuit;
a first resistor connected between the second input end of the switch circuit and the first control electrode of the first transistor;
a second transistor comprising a second control electrode, a third electrode, and a fourth electrode, wherein the third electrode is grounded, and the fourth electrode is connected to the first control electrode of the first transistor;
a second resistor connected between the first input end of the switch circuit and the second control electrode; and
a third resistor connected between the second electrode of the first transistor and the output end.

4. The network device for generating dying gasp signals as claimed in claim 3, wherein the switch circuit further comprises a capacitor, the capacitor having one end connected between the third resistor and the output end, and another end connected to ground.

5. The network device for generating dying gasp signals as claimed in claim 3, wherein the first transistor comprises a metal oxide semiconductor field-effect transistor (MOSFET).

6. The network device for generating dying gasp signals as claimed in claim 5, wherein in the first transistor, the first control electrode is a gate electrode, the first electrode is a source electrode, and the second electrode is a drain electrode.

7. The network device for generating dying gasp signals as claimed in claim 3, wherein the second transistor comprises an NPN transistor.

8. The network device for generating dying gasp signals as claimed in claim 7, wherein in the second transistor, the second control electrode is a base electrode, the third electrode is an emitter, and the fourth electrode is a collector.

9. The network device for generating dying gasp signals as claimed in claim 1, wherein the internal processing circuit comprises a digital signal processor.

10. The network device for generating dying gasp signals as claimed in claim 9, wherein the internal processing circuit further comprises an analog front end (AFE).

11. A network device for generating dying gasp signals, comprising:
an interrupt generating circuit for generating an interrupt signal when there is no power supplied to the network device;
an external connecting circuit for connecting to another network device or a network;
an internal processing circuit connected to the interrupt generating circuit, for generating a dying gasp signal according to the interrupt signal;
a switch circuit comprising a first input end, a second input end, and an output end,
wherein the first input end is connected to the interrupt generating circuit, and the output end is connected to the external connecting circuit;
a voltage adjusting circuit connected to the internal processing circuit and the second input end of the switch circuit; and
a capacitor having one end connected to the voltage adjusting circuit, and another end connected to ground.

12. The network device for generating dying gasp signals as claimed in claim 11, wherein the internal processing circuit, the voltage adjusting circuit and the capacitor are for connecting to a power supply.

13. The network device for generating dying gasp signals as claimed in claim 11, wherein the switch circuit comprises:
a first transistor comprising a first control electrode, a first electrode, and a second electrode, wherein the first electrode is connected to the second input end of the switch circuit;
a first resistor connected between the second input end of the switch circuit and the first control electrode of the first transistor;
a second transistor comprising a second control electrode, a third electrode, and a fourth electrode, wherein the third electrode is grounded, and the fourth electrode is connected to the first control electrode of the first transistor;
a second resistor connected between the first input end of the switch circuit and the second control electrode; and
a third resistor connected between the second electrode of the first transistor and the output end of the switch circuit.

14. The network device for generating dying gasp signals as claimed in claim 13, wherein the switch circuit further comprises a capacitor, the capacitor having one end connected between the third resistor and the output end of the switch circuit, and another end connected to ground.

15. The network device for generating dying gasp signals as claimed in claim 13, wherein the first transistor comprises a metal oxide semiconductor field-effect transistor (MOSFET).

16. The network device for generating dying gasp signals as claimed in claim 15, wherein in the first transistor, the first control electrode is a gate electrode, the first electrode is a source electrode, and the second electrode is a drain electrode.

17. The network device for generating dying gasp signals as claimed in claim 13, wherein the second transistor comprises an NPN transistor.

18. The network device for generating dying gasp signals as claimed in claim 17, wherein in the second transistor, the second control electrode second transistor is a base electrode, the third electrode is an emitter, and the fourth electrode is a collector.

19. The network device for generating dying gasp signals as claimed in claim 11, wherein the internal processing circuit comprises a digital signal processor.

20. The network device for generating dying gasp signals as claimed in claim 19, wherein the internal processing circuit further comprises an analog front end (AFE).
